(19) United States
(12) Patent Application Publication
(10) Pub. No.: US 2012/0111906 A1
(43) Pub. Date: May 10, 2012

(54) Plywood Carrier

(76) Inventor: Gerald Paul SanFilippo, Elmhurst, IL (US)

(21) Appl. No.: 12/943,293

(22) Filed: Nov. 10, 2010

(51) Int. Cl. A45F 5/00; B66C 1/44; B25J 1/00; B66C 1/42

(52) U.S. Cl. 224/191; 294/86.4

(57) ABSTRACT

The present invention relates to the construction industry; more specifically to the homebuilding industry and the carpenter trade. The invention is an apparatus which allows one skilled in the art an easier and more ergonomically-correct method to lift and carry traditional plywood sheets (also traditionally referred to as plywood panels) and traditional sheets of plaster board (also traditionally referred to as drywall or sheet rock or gypsum board) and similar sheets of other materials.

### BACKGROUND OF THE INVENTION

The present invention is related to the construction industry. More specifically to carrying sheets of plywood and other materials supplied in sheets, from a stack traditionally delivered to the job site by truck, to specific locations on said job site where needed.

Typically, 4′×8′ sheets of plywood of thicknesses of from ¼″ to ¾″ are used to sheath the floors, walls and roof of a newly constructed home. Other construction materials are also supplied to the job site as 4′×8′ sheets and must be carried by workers to specific locations on the job site. The present art is to grasp the edges of the sheet with the hands and lift the sheet about waist to shoulder high, long edge parallel to the ground and carry the sheet in that said position to the specific location where needed.

The above described plywood carrying method has several drawbacks.

On a windy day, this relatively simple task becomes a struggle to control the sheet once lifted waist to shoulder high.

Waist to shoulder high; being defined as the bottom long side of the sheet about waist high off the ground and the top long side up above the shoulder to above the head. This position of a 32 sq. ft. sheet can act as a sail on a boat and can be a challenge to carry and control.

Also, carrying a 4′×8′ sheet as hereinbefore described causes the sheet to partially block the vision of the carrier. This situation can be very hazardous on a cluttered construction site with numerous other workers, open holes and dangerous activities.

Also, if the panel is unfinished plywood or flakeboard made from wood chips, slivers of wood penetrating the hands and fingers is a constant concern and danger.

Also, the thin edge of plywood is relatively sharp and can cause extreme discomfort to the carrying hand, especially if the sheet is very heavy.

Often when a worker carries a sheet from a stack to a specific location near or upon the new construction itself, the sheet must be lowered down and rested on the ground or floor momentarily until the sheet can be located exactly where it is required in the construction process. Setting down and then again lifting a heavy sheet to the waist high position described herein is a relatively arduous task. A task that requires raising a sheet enough to place the hand under the bottom edge and then gripping the said bottom edge, which requires the bending down of the worker's body and then lifting the sheet from the awkward position of being bent over gripping the bottom edge of a 4′×8′ sheet, while holding the said sheet high enough off the ground with the other hand to allow the first hand to grasp the sheet.

The present invention is a very useful tool, which overcomes the drawbacks of the primitive current art of carrying said sheets on a construction job site and other places. Big box lumber departments and home centers are examples of other places the present invention may be utilized. The present invention would allow a single person to carry a said sheet from the stack to a cart or to the check-out and then to a truck.

To further explain the benefits of the present invention and the shortcomings of the existing art, one attempting to understand the present invention might consider the involvement of one not skilled in the art. One not skilled in the art would be one traditionally referred to in the construction industry, particularly in the homebuilding/remodeling industry as the homeowner or the weekend warrior. These persons are not necessarily skilled in the art, but commonly attempt do-it-yourself projects, which include similar considerations as projects by one skilled in the art.

One not skilled in the art considering a method of moving a sheet of building material as heretofore described in this disclosure often decides the best method is to involve an additional person to move said sheet; and perhaps correctly so. The present invention, while pertaining to one skilled in the art, is sufficiently simple to be employed by one not skilled in the art, thus eliminating the perceived need for an additional person in these aforesaid situations. The present invention is sufficiently low in cost to allow this consideration.

### SUMMARY OF THE INVENTION

The first example of an embodiment of the present invention is a very useful tool with which to carry plywood; refer now to FIG. 1 and FIG. 2. The procedure is approximately as follows: after standing the sheet vertically on a long edge, the present invention is placed loosely on the opposite long edge approximately at the center of the said sheet; allowing the edge of the sheet to enter gap 4 of the invention as far as possible. The cuff 1 of the invention is positioned on the said sheet as the opposite side of the person practicing the invention. Thus the invention hangs loosely from the said long top edge with the cuff 1 positioned with the padding 2 facing down. One skilled in the art reaches over the top edge of the sheet and places his or her forearm under the cuff 1 and against the padding 2 of the invention and lifts. The present invention then wedges against the sheet and allows the sheet to be lifted in an ergonomic manner using the forearm. The weight of the sheet is close in to the body of the person lifting. Thus the sheet is carried to the desired location.

When the sheet is eventually lowered to the ground, the one skilled in the art practicing the invention discontinues the lifting force brought to bear against the padding 2 and the cuff 1. Without the lifting force applied to the cuff 1, the invention releases from the sheet and hangs loosely from the top edge of the said sheet as at the beginning of the process. Finally, the present invention is lifted easily from the sheet and the worker returns back to the plywood supply carrying the invention and the procedure begins anew.

It is important to realize when attempting to understand the operation of the present invention that the apparatus does not attach onto the said sheet by the traditional means of a “C” clamp. The frame 3 of the present invention illustrated in FIG. 1 and FIG. 2 is visually similar to a traditional “C” clamp; however, the frame 3 is never used in the traditional manner of a “C” clamp. The traditional manner being defined as manipulating the mechanism of a traditional “C” clamp in order to tighten the said clamp onto an object positioned within the jaws of the said clamp. The first example of an embodiment of the present invention is placed LOOSELY upon the said top edge of the sheet by positioning the said top edge into gap 4 of the apparatus. Loosely, being defined as a sheet of ½″ thickness being positioned into a 1″ gap 4.

To further clarify: if placing the present invention upon the edge of the sheet, as described in the preceding paragraph would be considered step number one; then step number two would be to lift and carry the sheet. There never would be a step where an element of the apparatus which is the invention would be attached to the sheet by the traditional means of a traditional “C” clamp. Once the sheet edge is positioned into the gap 4 of the invention and the gap 4 is positioned upon the said edge of the sheet, the apparatus requires no further adjustment or manipulation of the elements to be practiced successfully by one skilled in the art.

The element of the first example of an embodiment of the present invention described herein as numeral 4 and illustrated and numerated 4 in FIG. 1 is an invented element of the present invention and is claimed in the present disclosures.

The second example of an embodiment of the present invention is new art and very useful to lift and carry, more safely and easier, a sheet of material more fragile than a sheet of plywood; for example, a 4′×8′ sheet of plasterboard.

Referring now to FIG. 3, FIG. 4, FIG. 5, FIG. 6, FIG. 7, FIG. 8, FIG. 9, and FIG. 10, the process is approximately as follows: one skilled in the art inserts his or her right or left hand into and through the cuff 19 and allows this embodiment of the present invention to hang from his or her forearm and over the top edge of a sheet resting vertically on the long edge; as depicted in FIG. 8.

Next, the person practicing the invention, one skilled in the art, lifts the said sheet slightly; high enough to position the bottom long edge into the material channel 21 of the invention; as depicted in FIG. 9.

Once the bottom edge of the sheet is into the material channel 21 and the said material channel 21 is approximately at the midpoint of the said bottom edge, the one skilled in the art bends his or her knees slightly and then using the muscles of the legs and the muscles of the arm in the cuff 19 and, of course, other muscles, lifts the cuff 19 and thus the said sheet; keeping the sheet and cuff 19 tight to his or her body; as depicted in FIG. 10.

The second example of an embodiment of the present invention as illustrated in FIG. 3 through FIG. 10 is to be manufactured to act as a relatively rigid one piece unit. Therefore, when the second example of an embodiment is affixed to the forearm of one skilled in the art, the material channel 21 can be maneuvered the amount necessary to engage the bottom edge of the said sheet by maneuvering the cuff 19, which will cause the material channel 21 to also move.

The methods and processes pertaining to the first example and the second example of embodiments of the present invention described herein are not intended to be all inclusive. One skilled in the art will best practice the present invention as determined by trial and error discovery.

The present invention in the first and second examples of possible embodiments herein explained and illustrated provides to the construction industry and others a much improved method to carry sheet materials easier and safer.

By practicing the present invention the said sheet can be carried close to the body to minimize stress, strain and fatigue; maximizing control.

The stress, discomfort and danger of wood splinters to the hand and arm using the present art carrying methods are eliminated because the present invention does not require the griping of the plywood edge to lift or carry the sheet.

Practicing the present invention allows the said sheet to be carried close to the ground, where the sheet is least vulnerable to the effects of the wind. Also, when carried close to the ground, the sheet is easier to set down on the ground and also to raise off the ground and requires less bending down and no bending down to an awkward position.

The present invention allows carrying of the said sheet in a position where the sheet does not obstruct the vision of one practicing the invention. Present traditional art of carrying said sheets causes the sheet to be carried at a height where the top edge of the sheet is above the carrier's head and obstructing the said carrier's vision in at least one direction.

The present invention is simple to affix to the said sheet and equally simple to remove.

The present invention is easy to master by one skilled in the art.

The present invention is very safe and eliminates many unsafe elements of the current art.

The present invention is low cost and durable.

The present invention requires no maintenance and is easy to store.

The present invention contains no pinch points to cause injury; and the weight of the invention is such that dropping the apparatus onto one's toes, while wearing typical work shoes, would cause minimal injury, if any.

The present invention eliminates the need to carry sheet on a construction site using the current art, which is to grip the bottom long edge with one hand and then lift the sheet approximately 32″ off the ground; about waist high; then grasp the other long edge with the other hand—the other edge thus being about 80″ off the ground. With the sheet at this height, wind loads against the sheet can cause one skilled in the art to lose control of said sheet; and if struggling with a sheet because of wind the said sheet is also difficult to safely set down on the ground. The present invention eliminates the problem of losing control due to wind in all but the most excessive wind.

The strain on the outstretched arm to reach the bottom edge of the sheet and then carry the weight of the sheet with the hand of the outstretched arm can be excessive on that said outstretched arm after carrying many successive sheets. This excessive strain is eliminated with the present invention as the apparatus of the present invention requires no gripping or carrying with an outstretched arm.

The existing art of bending down to grip a said sheet to be carried is more stressful on one skilled in the art than the present invention allows. The present invention permits one skilled in the art to stand erect when preparing to lift the said sheet and only bend slightly with the legs; and then further to lift the weight of the sheet from the upright position and lift with the strength of the leg muscles more than other muscles. Also, lifting with the weight of the sheet close in to one's body is the most efficient lifting method.

The present invention provides a much needed improvement in the position of a said sheet when carried inside a building with narrow hallways and narrow door openings and low ceilings. The low, close to the body position allowed by the present invention is ideal for carrying in a building.

The present invention is a much needed apparatus. The existing art of carrying sheets of materials is primitive.

Further, the present invention is easily practiced by one NOT skilled in the art; a person that may conclude that the best way to move a said sheet, without awareness of present invention, is to involve two co-operating persons to accomplish the task. The present invention is simple to master and low in cost so that a person not skilled in the art can eliminate the assumed requirement of a second person to complete the said task.

### BRIEF DESCRIPTION OF THE DRAWINGS

There are 5 pages of drawings containing FIG. 1 through FIG. 10.

FIG. 1 illustrates a perspective view of the first example of an embodiment of the present invention. The numerals and arrows are for reference to the specifications and claims.

FIG. 2 illustrates one skilled in the art practicing the first example of an embodiment of the present invention to lift and carry a sheet of plywood.

FIG. 3 illustrates a perspective view of the second example of an embodiment of the present invention. Numerals and arrows are for reference to the specifications and claims.

FIG. 4 illustrates a right side view of the second example of an embodiment of the present invention.

FIG. 5 illustrates a back view of the second example of an embodiment of the present invention.

FIG. 6 illustrates a front view of the second example of an embodiment of the present invention.

FIG. 7 illustrates a left side view of the second example of an embodiment of the present invention.

FIG. 8 illustrates one skilled in the art preparing to lift and carry a traditional sheet of plaster board practicing the second example of an embodiment of the present invention.

FIG. 9 illustrates one skilled in the art positioning the bottom edge of a traditional sheet of plasterboard in to the material channel 21 of the second embodiment of the present invention.

FIG. 10 illustrates one skilled in the art practicing the second example of an embodiment of the present invention to lift and carry a traditional sheet of plasterboard.

### DETAILED DESCRIPTION OF THE INVENTION

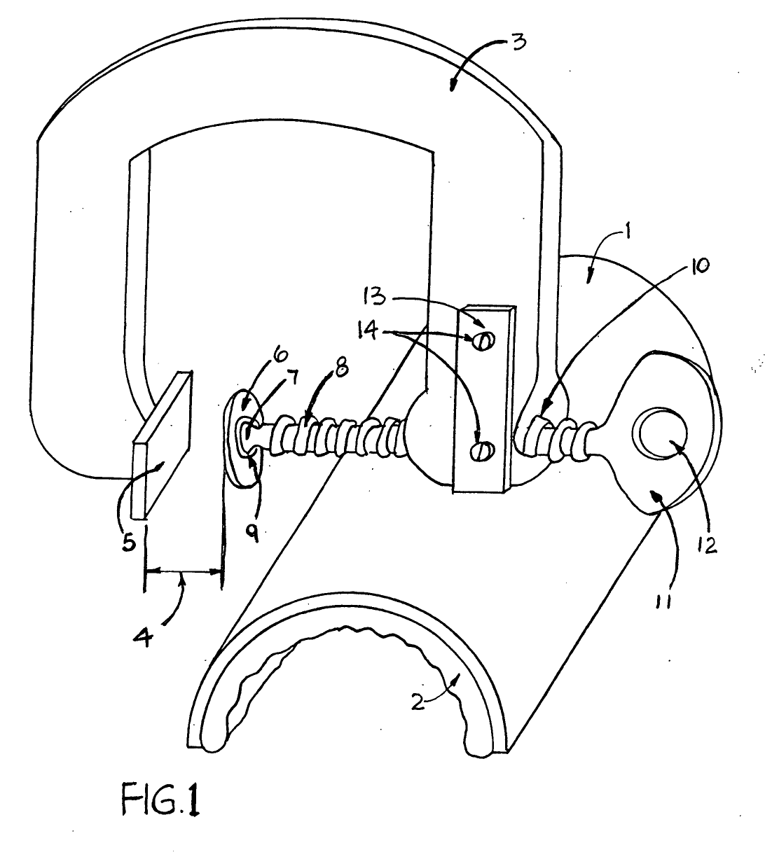

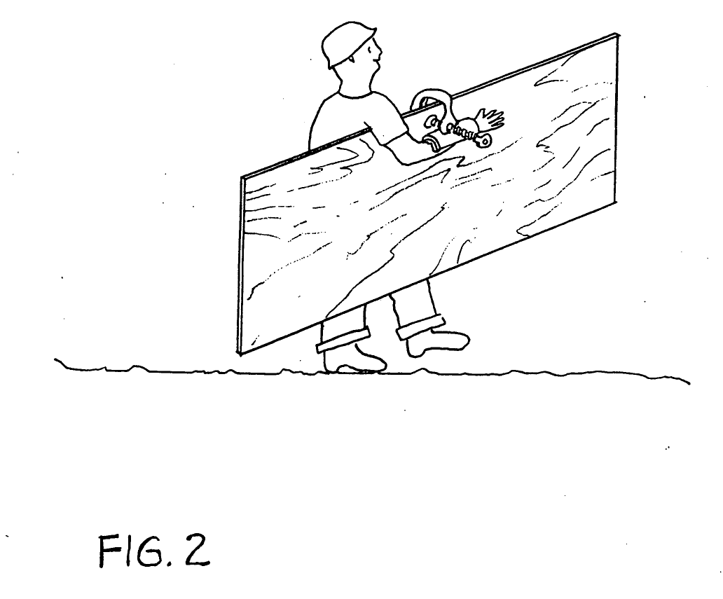

Referring to FIG. 1 AND FIG. 2: FIG. 1 illustrates the first example an embodiment of the present invention; specifically configured to lift and carry plywood sheets of approximately 4′×8′ size. The 4′×8′ is a standard traditional dimension. The effectiveness of the present invention is not limited by exact size or the number of sheet(s) carried at one time. The number and/or size of said sheet(s) is, in practice, limited by the strength and size of the one skilled in the art practicing the invention.

Numeral 1 of FIG. 1 indicates the cuff of the apparatus, which is the present invention. Numeral 2 indicates the cuff padding. Cuff padding 2 comforts the forearm of one skilled in the art practicing the invention. The cuff 1 fitted with the cuff padding 2 is the element of the present invention to which the power to lift the invention, and thus the said plywood sheet or sheets, is applied by one skilled in the art.

Numeral 12 indicates a hole or opening where hoisting equipment, not part of the present invention, may be attached to apply power in order to lift the invention and thus lift the said sheet(s).

Without hoisting equipment, the situation focused upon by the present disclosure of the present invention, the said power is supplied and produced by the arm muscles and other muscles of one skilled in the art.

The said focus of the present disclosure does not in any way or fashion limit the present invention's use.

The said lifting muscle power is applied by one skilled in the art by placing his or her arm in such a position to cause the cuff 1 and padding 2 as fitted to cuff 1 to be above and upon the forearm of one skilled in the art as illustrated in FIG. 2. One skilled in the art, having positioned his or her arm in the said position, next raises that arm and forearm upward, using the strength of the necessary muscles, to force the forearm upward and, at the same time, close to the body as illustrated in FIG. 2.

The frame 3 of the present invention illustrated in FIG. 1 maintains the elements of the said invention in the correct relationship and proximity to each other. The gap 4 is indicated by the numeral 4 indicating a dimension indicating line with arrows at either end. This said dimension indicating line indicates an arbitrary size which is variable and adjustable. The said gap 4 is the space between the anvil 5 of the frame 3 and the swiveling seat 6. The swiveling seat 6 swivels by means of a spherical shaped element 7 formed into the end of the adjusting screw male threaded rod 8. Fitting into a matching conical shape 9 on the backside of said swiveling seat 6. The said gap 4 or distance between the said swiveling seat 7 and anvil 5 can be varied by the turning, in a clockwise or counter clockwise direction, the adjusting male treaded rod 8 contained in the matching female treaded opening 10 formed into the frame 3. Frame 3 is attached to the cuff 1 by means of a bracket 13 and fasteners 14.

An opposite view of FIG. 1, not included herein, is similar but reversed.

The end of the adjusting screw 8 opposite the swiveling seat 6 is a formed handle element 11, which serves to more easily turn the adjusting screw threaded rod 8 to cause the gap 4 to vary in size.

There is a hole or opening in the handle element 11, which serves as an attachment opening for a hook of hoisting equipment used to hoist plywood sheets by means including the present invention.

The gap 4 is adjusted before practicing the invention to a size befitting the thickness of the sheet or combined thicknesses of multiple sheets to be carried. However, it is important to understand that the purpose of said gap 4 is not a gap to be reduced or narrowed to attach the apparatus, which is the invention firmly to the said sheet(s) before the lifting process commences.

The gap 4 of the apparatus which is the present invention is nominal in relation to the thickness of the sheet of plywood; that is, a single sheet of plywood of ½″ thickness requires a gap 4 of ⅝″ up to about 2″. The actual size of gap 4 is determined by one skilled in the art practicing the invention in regards to the ease of operation preferred as determined by trial and error.

The size of the said gap 4 having been adjusted to a size determined by said trial and error by one skilled in the art; the present invention is placed loosely over and on top of the long dimension edge of the said sheet as said sheet rests vertically on the ground on the opposite edge.

Then, one skilled in the art takes a position near the midpoint of the long dimension of the sheet and reaches over the top edge of said sheet to place his or her forearm under said cuff 1 and under cuff padding 2. FIG. 2 illustrates the position described here above as one practicing the said invention has lifted and is carrying said sheet; the herein described apparatus, which is the invention having securely wedged the plywood sheet between the anvil 5 and the swiveling seat 6 elements of the present invention; the weight of the plywood sheet is providing the force to wedge the said sheet into and onto the present invention. The one skilled in the art would now walk carrying the said sheet to the required destination on the job site.

The said sheet(s) are in an ideal position for carrying; close to the body for ideal ergonomics and close to the ground to minimize the effects of wind blowing against the sheet. In the event of a high speed wind gust, to the degree of causing loss of control of the sheet, the sheet is easily lowered to the ground to regain control; the lowering being immediate.

Also, for one skilled in the art, the arm might require rest from the carrying activity; the sheet may be then lowered immediately and easily to rest on the ground removing the load from the arm and granting immediate relief.

Also, if a delay or interruption occurs in the route of the carrying the plywood load is easily lowered to rest on the ground and easily lifted to continue the carrying task.

The low carrying position during the conveying task as permitted by the present invention does not cause the plywood sheet to block the vision and view of one practicing the invention so, therefore, allows a much safer method of carrying on a typical job site with uneven ground and many obstacles including moving vehicles, open holes and other workers.

The said low carrying position is also safer and helpful inside the building where narrow hallways, doorways and low ceilings are obstacles.

The gap 4 is very nominal resulting in an apparatus, which is the invention, to be almost instantly fitted to the edge of the sheet and also instantly removed permitting rapid continuation of the task of carrying sheet after sheet, after sheet.

Typically, one skilled in the art will approach a stack of plywood laying in an even stack upon the face side; then stand one sheet on edge; then drop the present invention onto the midpoint of the top edge; then, without adjusting or tightening the present invention apparatus, reach over the sheet and by practicing the invention lift and carry the sheet. When the destination is reached, the sheet is lowered and the apparatus is easily, without any loosening or adjusting, removed from the sheet and brought back to the stack for a repeat performance.

One skilled in the art can easily judge the midpoint of the said sheet or another point where trial and error have indicated is the best point to locate the said invention. If a misjudgment of the point is made, instant and simple movement of the invention apparatus is possible.

The element of the present invention illustrated in FIG. 1 and numerated 13, with fasteners 14, is an element whose purpose is to attach the cuff 1 to the frame 3 and may take alternate forms other than the form illustrated.

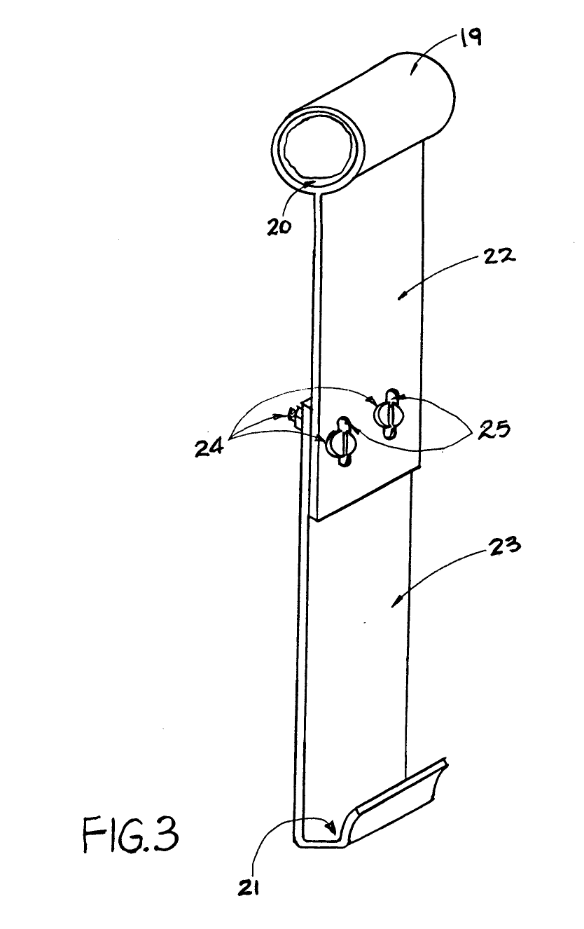

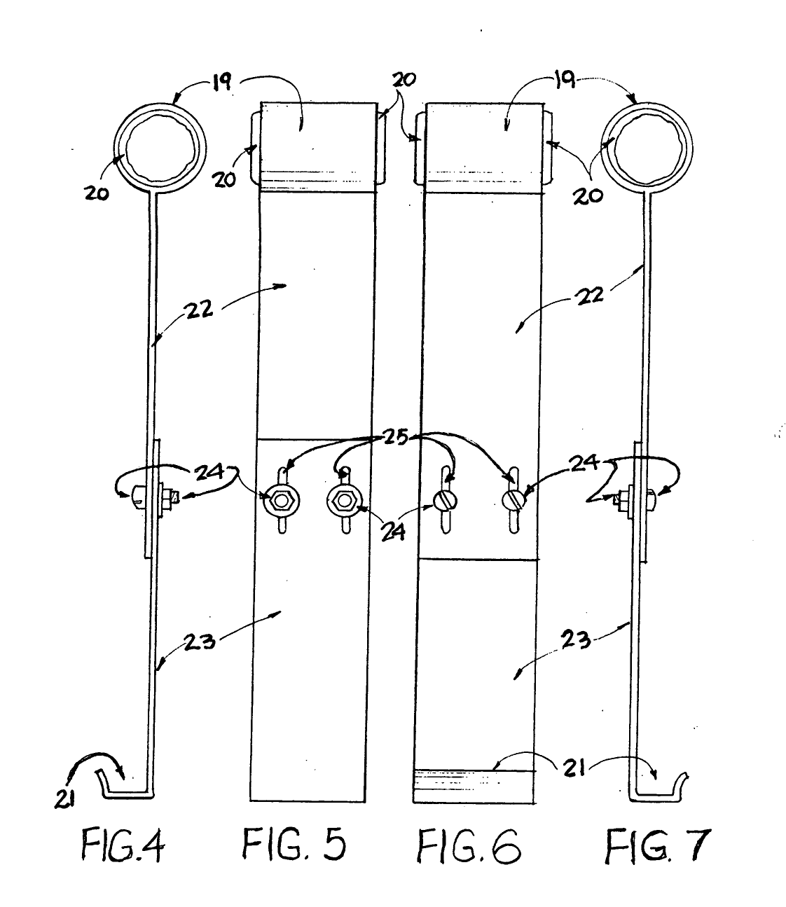

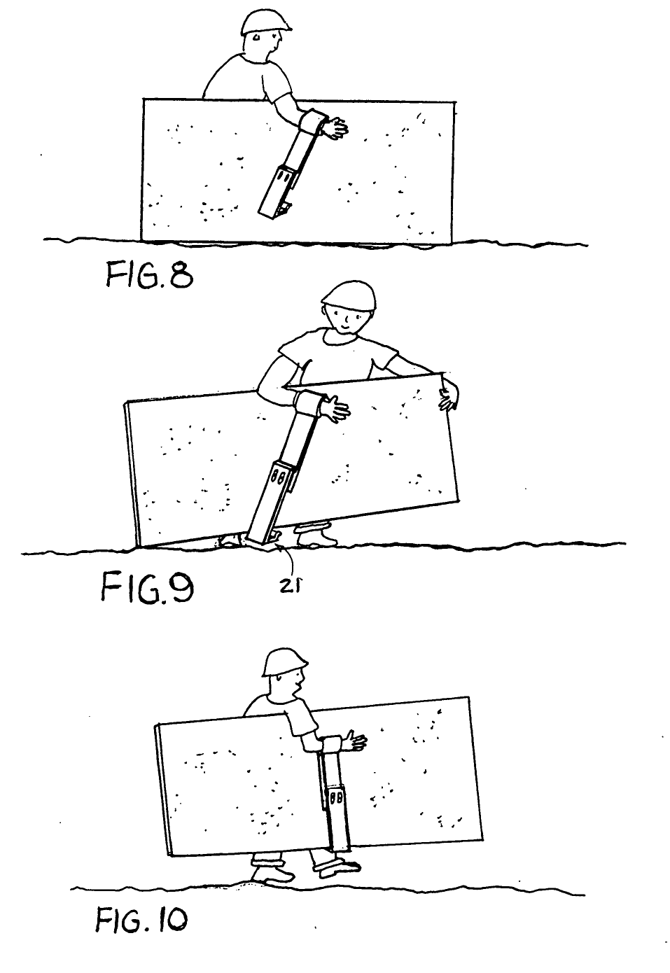

The first example of an embodiment of the present invention as described and illustrated herein is an apparatus to move easily and safely carry a sheet or sheets of traditional plywood. The present invention permits a vastly improved method over and beyond the existing art. Another example of an embodiment of the present invention is illustrated in FIG. 3, FIG. 4, FIG. 5, FIG. 6, FIG. 7, FIG. 8, FIG. 9 and FIG. 10.

In reference to a second example of an embodiment of the present invention refer to FIG. 3 through FIG. 10. Various construction materials are available in traditional 4′×8′ sheets. Masonite® siding, gypsum wall and ceiling sheathing traditionally referred to as plasterboard or drywall, rigid wall sheathing made of foam and various other materials are examples.

Some of these materials are less sturdy and less strong than plywood and could be damaged by the wedged process of the first example of an embodiment of the present inventions as illustrated in FIG. 1 and FIG. 2.

Referring now to FIG. 3 through FIG. 10; a second example of an embodiment of the present invention is illustrated. FIG. 6 illustrates a front view of the embodiment, FIG. 5 illustrates a rear view, FIG. 7 illustrates a left view, FIG. 4 illustrates a right side view and FIG. 3 illustrates a perspective view. These five figures have numerals and arrows to identify various elements as described in the text of the specifications and claims.

Numeral 19 indicates the enclosed arm cuff of the embodiment. Numeral 20 indicates the comfort padding of the arm cuff 19. The padding 20 protects the arm and forearm of one skilled in the art from any sharp or irritating edges of other elements of the present invention. Numeral 21 indicates the material channel into which the bottom edge of the said sheet is placed and positioned and which supports the weight of the sheet being lifted and carried. The material channel 21 is formed as part of lower lifting member 23. The cuff 19 is formed as part of the upper lifting member 22. The lower lifting member 23 is joined and attached to the upper lifting member 22 by means of appropriate sized fasteners 24 located in slotted holes or openings 25. The slotted nature of hole 25 permits the adjustment of the overall length of the embodiment to suit one skilled in the art practicing the embodiment.

FIG. 8 depicts one skilled in the art standing near the midpoint of a said sheet. Said sheet is resting with its long edge on the ground and is in the vertical position. The worker has his hand through the cuff 19 and the present invention is hanging from his forearm.

FIG. 9 depicts the worker continuing to practice the present invention by slightly raising the long edge of the sheet from its resting position on the ground and placing said edge into the material channel 21 of the present invention.

FIG. 10 depicts the said worker continuing to practice the invention by lifting and carrying said sheet by holding the sheet low and close to his body using the muscles of his arm and legs.

The material channel 21 of the second example of an embodiment of the present invention causes less strain per square inch upon the said sheet. Consequently, less strong materials such as said plasterboard and Masonite® and others can be carried by the second example of an embodiment of the present invention, which provides the same ergonomic and safety benefits as the first example of an embodiment of the present invention.

Although the descriptions and drawings of the said examples of embodiments of the present invention are set forth with a measure of particularity, it is understood that the present disclosure has been made to show examples to explain the spirit and scope of the present invention as hereinafter claimed.

To explain further the operation of the first example of an embodiment of the present invention a general comparison to a common device or tool or apparatus is hereby made to expand and elaborate the description of the present invention. The somewhat obsolete task of carrying a common block of ice prevalent in the era preceding modern refrigeration, commonly employed an apparatus known as ice tongs. These ice tongs fastened themselves to a block of ice in a manner not unlike the manner in which the present invention attaches to the said sheet of material to be carried by the apparatus which is the present invention. That is, simply put, the weight of the object being carried provides the gripping force to attach or bind the said object temporarily to the apparatus.

Further to explain: if a common sheet of paper, 8½″ by 11″, is carried by placing one's thumb and forefinger over the edge of the paper and then squeezing the paper with those fingers to attach the said fingers to the sheet of paper, that would NOT be an example of the manner in which the first example of an embodiment of the present invention operates to carry a sheet of plywood.

Rather, generally as in the operation of the said ice tongs, the gap 4 of the present invention, as created by the anvil 5 and the swiveling seat 6 of the invention, as fitted onto the edge of the said sheet, act and operates to wedge the said sheet into and onto the apparatus of the present invention by the force of the weight of the said sheet as the apparatus and thus the said sheet is being lifted.

What I claim:

1. An Apparatus to lift and carry traditional sheets of building materials.

2. Further in reference to claim 1 an apparatus to carry said sheet close to the body.

3. Further in reference to claim 1 an apparatus which contains an adjustable gap, which grips the said sheet by binding and wedging the apparatus to the said sheet.

4. Further in reference to claim 1 and claim 2 an anvil and a swiveling seat; said swiveling seat attached pivotally to an adjustable rod which creates the adjustable gap of claim 2.

5. Further in reference to claim 1 and claim 3 and claim 4, a “C: shaped body which allows the elements of claim 4 to be positioned and held in the correct relationship and proximity to each other to form the gap of claim 3.

6. Further, in reference to claim 4 a handle formed into the said adjustable rod at one end to turn and thus adjust said rod.

7. Further in reference to claim 4 an opening or hole by which hoisting equipment may be attached. (Said hoisting equipment not part of this invention.)

8. Further in reference to claim 5 and claim 1 an attachment bracket and fasteners in order to attach the “C” shaped body to the cuff of the invention.

9. Further in reference to claim 1 and claim 8 a cuff with applied padding into and onto which, one skilled in the art positions and places their forearm in order to practice the invention as described as the first example of an embodiment of the present invention.

10. Further in reference to claim 1 and claim 9 an enclosed cuff with applied padding into and through which, one skilled in the art places their arm in order to position their forearm inside the said cuff in order to practice the invention as described as the second example of an embodiment of the present invention.

11. Further in reference to claim 1 and claim 9 and claim 10, padding for the comfort of the area of the forearm in contact with the cuffs of claims 9 and claim 10.

12. Further in reference to claim 1, an apparatus described in the present disclosure as a first example of an embodiment of the present invention and also an apparatus described in the present disclosure as a second example of an embodiment of the present invention.

13. Further in reference to claim 1, an embodiment of the invention which is referred to in this present disclosure as a second example of an embodiment of the present invention where said second embodiment pertains to said sheets of materials that are, in nature, more fragile than said sheet of plywood.

14. Further in reference to claim 1 and claim 13, an apparatus which can be adjusted easily to suit persons of different sizes.

15. Further in reference to claim 1, claim 3, and claim 13, a material channel which contains and holds the said sheet in a more gentle manner than the manner of claim 3.

16. Further, in reference to claim 1 and claim 13, an apparatus which is generally rigid and acts as one piece when adjusting elements are securely fastened as intended.

17. Further, in reference to claim 1, claim 13, claim 14 and claim 16, adjustment slotted holes and fasteners to facilitate the adjustment of claim 14.
